(19) United States
(12) Patent Application Publication
(10) Pub. No.: US 2011/0031169 A1
(43) Pub. Date: Feb. 10, 2011

(54) METHOD AND APPARATUS FOR SORTING PARTICLES

(75) Inventors: Thomas FOLGNER, Freiberg (DE); Georg UNLAND, Freiberg (DE); Martin STEUER, Riesa (DE)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: TECHNISCHE UNIVERSITAT BERGAKADEMIE FREIBERG, Freiberg (DE)

(21) Appl. No.: 12/849,297

(22) Filed: Aug. 3, 2010

Related U.S. Application Data
(63) Continuation of application No. PCT/EP2009/000668, filed on Feb. 2, 2009.

(30) Foreign Application Priority Data
Feb. 4, 2008 (EP) 08 002 067.0

(51) Int. Cl. B07B 1/00; B07B 13/04; B07B 15/00

(52) U.S. Cl. 209/234; 209/233

(57) ABSTRACT

Methods and an apparatuses are provided for sorting particles according to the shape thereof in at least two classification stages in a chronological or spatial sequence.

### CROSS-REFERENCE TO RELATED APPLICATIONS

This application is a continuation of International Application No. PCT/EP2009/000668, filed Feb. 2, 2009, which was published in the German language on Aug. 13, 2009, under International Publication No. WO 2009/098013 A2 and the disclosure of which is incorporated herein by reference.

### BACKGROUND OF THE INVENTION

The invention relates to a method and an apparatus for sorting particles.

In processing technology and for product manufacture using particles, the use of sorted particulate material is playing an increasing role for high efficiency and for satisfying quality demands. Moreover, by providing sorted particulate products, higher quality and price expectations can be realized. For example, sorted upscale stone chippings and broken stone in construction industry and road construction can result in essentially longer service lives and improved product properties.

From German published patent application DE 10 2006 001 043 A1, a method for generating stone chippings and broken stones is therefore already known, in which cubic grains, of which the proportion in broken stone and stone chippings is to be at least 50%, are not crushed further in a later processing process, such as a breaking process. Preferably, only non-cubic grains are to be processed to cubic grains in further breaking stages that serve cubification. For sorting, grain shape sorting machines are employed, which are either based on optical principles or on the different equilibrium behavior of cubic and non-cubic grains.

### BRIEF SUMMARY OF THE INVENTION

By the present invention, a method and an apparatus for sorting particles are to be provided for a wide, cross-branch application, which reliably permit the provision of particles, such as stone chippings or broken stone or other bulk forms, in grain-shape-specific sorting and can be applied in industry.

According to the invention, this object is achieved by a method of the type mentioned in the beginning, wherein particles are sorted according to their particle shape in at least two stages in a chronological and/or spatial sequence.

That means, an essential aspect of the present invention is to sort particles according to their grain shape and in this manner separate particles of different grain shapes from each other to thus distinguish between particles, e.g., according to their acicularity (particles having a predetermined length/width ratio), cubicity or roundness, respectively (particles having a predetermined length/thickness ratio), or to their flatness (particles having a predetermined width/thickness ratio).

Within the scope of the present invention, the terms “classification” and “sorting” will be used. Classification here means the separation according to a geometric feature of the particle's macro shape (e.g., main dimensions as shown in FIG. 1). Sorting according to the grain shape is described by the serial classification according to at least two geometric features of the particle's macro shape (serial classification according to at least two main dimensions), wherein double serial classification can be performed, e.g., according to the parameters acicularity, cubicity or flatness.

Preferably, classification according to a geometric feature of a particle's macro shape (main dimension) is chronologically and/or spatially preceded by classification according to a further geometric feature of a particle's macro shape (main dimension).

In this manner, for example, one fraction can be separated according to acicularity at a predetermined limiting value for this grain shape.

Preferred embodiments of the method according to the invention, also with respect to the design of the apertures depending on the classification task, are discussed below.

Preferably, a two-dimensional classification (performed in the classification plane), or even a three-dimensional classification, can be realized using spatial three-dimensional screen structures.

In the course of the method according to the invention, serial classification (sorting according to the grain shape) is performed in at least two classification processes, which are preferably chronologically and/or spatially consecutive, taking into consideration one of three main dimensions each (length a, width b, thickness c) of the particles.

According to the invention, the above-mentioned object is achieved with respect to the apparatus by a first classification apparatus for classifying the particles according to one of three geometric main dimensions (maximal length, maximal width or maximal thickness), and a further classification apparatus for classifying the particles according to a further one of their main dimensions which is different from the first main dimension.

According to a preferred embodiment of the invention, the first and the second classification apparatus can be formed by a first and a second screen which are preferably arranged in a common housing or integrally embodied in one classification plane.

Preferably, the particle movement in the form of the screen number and the corresponding particle dimension (e.g., particle length, particle width and particle thickness) according to which classification has to be performed are used as parameters for the selection of suited geometries of the apertures of the screen.

By the double serial classification according to the invention, i.e., the sorting of the grain shape according to the particle size in at least two main axial directions of the particle which are essentially perpendicular with respect to each other (length, width, thickness), it is possible in a surprisingly simple manner to sort particles with respect to their acicularity (ratio of the maximal particle dimension (linear dimension) to the maximal median or middle main dimension (particle width)) or to their cubicity or roundness (ratio of the maximal particle dimension (linear dimension) to the minimal particle dimension (thickness)), or with respect to their flatness (ratio of the median main dimension (width) to the smallest main dimension (thickness)), i.e., according to one geometric class each of the particle. Preferably, the classifier are screens, such as circular, elliptical, linear or flat vibrators, i.e., vibrating screens with the above-mentioned geometry of movement, or a screen surface arranged to be inclined and preferably fixed as classification plane over which the particles are guided.

For a classification according to the maximal particle dimension, the classifier, preferably a screen, involves classification by using a predetermined round hole, square hole, oblong hole (two-dimensional classification), 3D square hole or 3D rectangular hole (“3D”=three-dimensional classification). In view of a median particle dimension essentially perpendicular to the above-mentioned particle dimension, the screen is preferably provided with apertures (round hole or square hole, respectively) having a predetermined hole diameter or mesh size, preferably in a design as a perforated plate or screen.

As classifier for classifying the particles according to the minimal particle dimension essentially perpendicular to the maximal and median particle dimensions, a screen formed of bars with predetermined bar distances or a long mesh with predetermined mesh distances or a 3D square hole lining is preferably provided.

That means classification can be preferably performed by a screen with a two-dimensional or even with a three-dimensional function or classification plane, respectively.

Within the scope of the present application, classification or double serial classification always means sorting according to the grain shape including a chronologically and/or spatially separated classification according to at least two geometric main dimensions of the particles (maximal length, maximal width or maximal thickness).

By the present invention, for example, bulk material can be easily produced which is adjusted to certain preferred applications or qualities with respect to uniform particle geometries, e.g., in the production of upscale multiple-crushed chippings.

The invention is based on the surprising finding that high-quality sorting of particulate goods according to the grain shape (serial classification) is possible by performing at least two classifications in combination, namely on the basis of the geometric main dimensions of the particles (maximal length, maximal width, maximal thickness).

Here, at least two classifications can be performed in a close chronological and/or spatial connection and vicinity, as well as at a long chronological and/or spatial distance. In this manner, it is possible to separate a fraction of acicular particles from a fraction of round or cubic particles, and these in turn from a fraction of flat particles, wherein further fine fractionations can be generated, e.g., particles having a predetermined acicularity by limiting the median particle dimension (particle thickness) or the predetermined flatness of the particles (limitation of the smallest dimensions (thickness) of the particles) by connecting corresponding screens within each fraction in series.

The invention can be applied to the fractionation and quality improvement of stone chippings or broken stone in the construction industry or in the provision of coal for blast furnaces or for the preparation of beds for fixed bed reactors, as well as, for example, in the predisposition of particles for suspensions of application materials.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic, perspective representation of a particle according to its main dimensions;

FIG. 2 is a table of classification variants;

FIG. 3 is a schematic diagram of an equilibrium of forces at a particle for describing possible modes of vibration of a screen;

FIG. 4 are schematic diagrams of a movement pattern of a particle depending on a movement/drive of a screen for a throwing movement (FIG. 4a) and a sliding movement (FIG. 4b) of the particle;

FIG. 5 is a diagram showing aperture geometries of a screen with two-dimensional aperture geometries of the screen for a round hole (circular hole) (a), square hole (b), rectangular aperture (c), and elliptical aperture (d);

FIG. 6 is a set of diagrams showing three-dimensional aperture geometries of a screen with a square hole in a cross-section and a plan view (FIGS. 6a and 6b) and a rectangular hole in a cross-section and a plan view (FIGS. 6c and 6d);

FIG. 7 is a set of diagrams showing the functionality of aperture geometries according to FIG. 6 with schematic representations of three-dimensional aperture geometries, where FIG. 7a shows a classification according to a maximal particle dimension (a), and FIG. 7b shows a classification according to a minimal particle dimension (c);

FIG. 8 is a set of diagrams showing the functionality of aperture geometries according to FIG. 7 with schematic representations of three-dimensional aperture geometries, where FIG. 8a1 shows a classification according to a maximal particle dimension (a) and FIG. 8a2 shows a different center-of-gravity position, and FIG. 8b shows a classification according to a minimal particle dimension (c);

FIG. 9 is a series of perspective illustrations showing functionalities of aperture geometries for various particle shapes in a sliding movement;

FIG. 10 is a series of perspective illustrations showing functionalities of aperture geometries for various particle shapes in a throwing movement;

FIG. 11 is a set of schematic representations of the operating principle of a double serial classification of the present invention showing a first classification stage and a second classification stage;

FIG. 12 is a set of schematic representations of a screen as a vibrating screen for determining possible modes of vibration;

FIG. 13 is an equivalent circuit diagram for a combination of vibration stimulation, circular vibration and elliptical vibration for an integral screen;

FIG. 14 is plan view of an embodiment of a screen with a perforated plate and a screen grate according to FIG. 11 (classification according to acicularity);

FIG. 15 is a diagram of a procedural model of a sorting machine with double serial classification;

FIG. 16 is a schematic sectional representation of a sorting apparatus (sorting according to acicularity);

FIG. 17 is a schematic sectional representation of a discharge section of the sorting apparatus according to FIG. 16;

FIG. 18 is a plan view of a screen of the sorting apparatus according to FIG. 16;

FIG. 19 is a schematic sectional representation of a sorting apparatus (sorting according to acicularity) with classification steps on separate screen;

FIG. 20 is a schematic sectional representation of a discharge section of the sorting apparatus according to FIG. 19;

FIG. 21 is a plan view screen of the sorting apparatus according to FIG. 19;

FIG. 22 is a schematic sectional representation of a sorting apparatus (sorting according to cubicity);

FIG. 23 a schematic sectional representation of a discharge section of the sorting apparatus according to FIG. 22;

FIG. 24 is a plan view of a screen of the sorting apparatus according to FIG. 22;

FIG. 25 is a schematic sectional representation of a sorting apparatus (sorting according to cubicity) with the classification stages on a separate screen;

FIG. 26 is a schematic sectional representation of a discharge section of the sorting apparatus according to FIG. 25;

FIG. 27 is a plan view of a screen of the sorting apparatus according to FIG. 25;

FIG. 28 is a schematic sectional representation of a sorting apparatus (sorting according to flatness);

FIG. 29 is a schematic sectional representation of a discharge section of the sorting apparatus according to FIG. 28;

FIG. 30 is a plan view of a screen of the sorting apparatus according to FIG. 28;

FIG. 31 is a schematic sectional representation of a sorting apparatus (sorting according to flatness) with classification stages on a separate screen;

FIG. 32 is a schematic sectional representation of a discharge section of the sorting apparatus according to FIG. 31;

FIG. 33 is a plan view of a screen of the sorting apparatus according to FIG. 31.

### DETAILED DESCRIPTION OF THE INVENTION

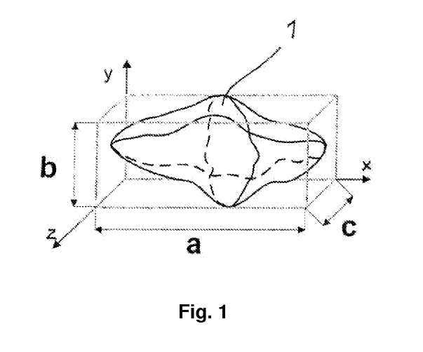

The basis of the following explanation of embodiments of a method and an apparatus for sorting particles according to their particle shape by double serial classification is the geometry of a particle 1, as represented in FIG. 1, by way of its main dimensions, that means its maximal length a, its median dimension width b and its smallest dimension thickness c, wherein these dimensions can be represented as an envelope in the main axes x, y, z of the particle 1 by a regular body, e.g. a cuboid, as is shown in FIG. 1. The main dimensions a (longest body edge of the enveloping cuboid), b (median body edge of the enveloping cuboid), and c (smallest body edge of the enveloping cuboid) with a>b>c geometrically describe the particle 1.

The double serial classification hereinafter explained more in detail, i.e., the determination of the particle shape on the basis of at least two geometric main dimensions of the particle 1, is based on the above-mentioned detection of the main dimensions of the particle and its realization with respect to the method and apparatus. The shape of the particle 1 can be completely detected by using this detection of its dimension in the three main axes x, z, and y.

By using the main dimensions of the particle 1, three different particle shapes can be defined, which are determined by two aspect ratios each.

The ratio of the longest main dimension a to the median main dimension b describes the elongation or acicularity of the particle 1:

$${Ψ}_{( a / b )} = \frac{a}{b}$$

The ratio of the longest main dimension a to the smallest main dimension c describes the cubicity or roundness or dice-shape, respectively, of the particle 1:

$${Ψ}_{( a / c )} = \frac{a}{c}$$

The ratio of the median main dimension b to the smallest main dimension c describes the flatness of the particle 1:

$${Ψ}_{( b / c )} = \frac{b}{c}$$

By using the above description or sorting of a particle quantity according to grain shapes Ψ_{(a/b)}, Ψ_{(a/c)}, Ψ_{(b/c)}, a charging material consisting of particle 1 can be sorted according to its acicularity in two classification steps performed in spatial and/or chronological sequence (classified serially), so that two fractions with two significantly different grain shape numbers Ψ_{(a/b)} are formed. It is correspondingly possible to sort the particle mixture according to cubicity or flatness.

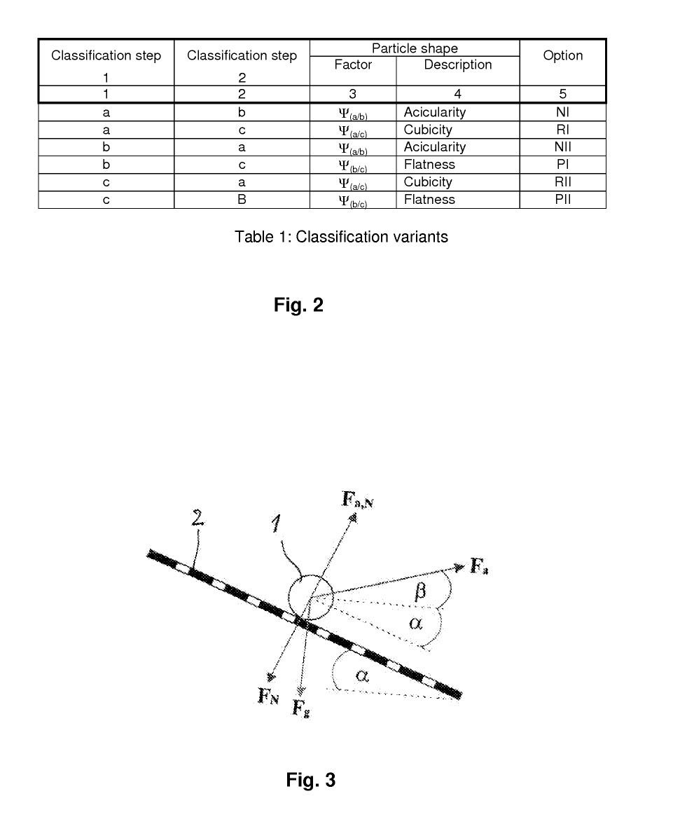

The classification variants in a double serial classification, i.e., sorting according to the grain shape corresponding to the main dimensions a, b or c, are shown in table form in Table 1 of FIG. 2. Depending on the combination of the classification according to the three main dimensions in a first and a second classification step, sorting according to the following grain shapes results: acicularity, cubicity or flatness, as illustrated in FIG. 2. FIG. 2 shows the combination of the various classification steps, i.e., a first classification (classification step 1) and a subsequent second classification (classification step 2) with the corresponding classification result and the description of the grain shape in each of these variants with an abbreviation in the right column of FIG. 2. As can be seen, by a combination of the first and the second classifications according to the main dimensions a and b, as well as b and a (sequence), sorting is effected according to acicularity, while with sorting according to other main dimensions in different sequences, a sorting according to cubicity or flatness, respectively, is performed each, as can be seen in FIG. 2.

Sorting according to the grain shape (serial classification) is performed on the basis of the main dimensions in the embodiments explained here by one or several screens, where in the embodiment of the screen for satisfying the respective sorting task of the sorting of the particle shape according to at least one of the main dimensions a, b or c, a particle movement and a screen aperture geometry, i.e., a geometry of apertures of the screen, are considered as parameters. Here, the particle movement is described by using a dimension figure which is formed by the ratio of the component of the accelerating force Fₐ and the weight force F_{g} acting on a particle 1 that is perpendicular with respect to a classification plane of the screen (screen plane). This dimension figure is referred to as screen or throw number Sᵥ. In FIG. 3 the equilibrium of forces acting on a particle 1 in the particle acceleration is represented for describing/detecting possible movement patterns for a screen 2. The screen number is calculated as follows:

$${S}_{v} = \frac{{F}_{a , N}}{{F}_{g , N}} \\ {S}_{v} = \frac{{F}_{a} \cdot sin ( α + β )}{{F}_{g} \cdot cos ( α ) \\ with \text{:} {F}_{a} = {m}_{p} \cdot a \\ with \text{:} {F}_{g} = {m}_{p} \cdot g \\ {S}_{v} = \frac{a \cdot sin ( α + β )}{g \cdot cos ( α )}} \qquad ( 8 )$$

Here, mₚ is a particle mass, α the setting angle of a screen plane (classification plane) or of a classification lining of the screen 2, and β a setting angle of a vibration drive of the screen. For describing a particle movement along the screen 2 or along a classification lining, one distinguishes between a throwing movement with Sᵥ>1 and a sliding movement Sᵥ≦1.

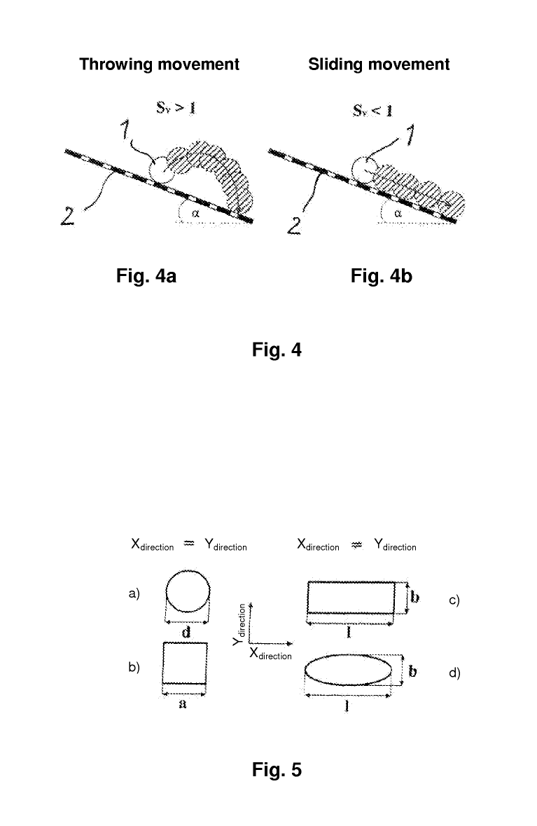

In FIGS. 4a and 4b the movement conditions of a round model body are represented in a throwing or sliding movement.

As a sorting apparatus for classifying particles 1, vibrating screens (screen 2 with a vibration drive) are preferably used, or a screen 2 which, being inclined, causes a sliding movement of the particles 1 along the screen 2 in the classification plane due to the inclination while the screen 2 is at rest, as is schematically shown in FIG. 4b. The screen 2 can preferably undergo a circular vibration, an elliptical vibration or a flat vibration. As screen aperture geometries, which describe the geometry of the apertures 3 of a screen lining 2, a round hole, a square hole, an oblong hole (as two-dimensional aperture geometries), a 3D square hole (three-dimensional aperture geometry), or a 3D oblong hole (three-dimensional aperture geometry) are preferably provided.

That means it is preferably possible to distinguish between screens or screen linings 2 with a two-dimensional aperture geometry of apertures (here referred to as 2D screen linings) and screen linings with a three-dimensional geometry of the apertures (here referred to as 3D screen linings). Both geometries can also be connected in an (integral) screen.

For a 2D screen lining 2, the aperture geometries of the apertures 3 are shown in FIG. 5. Provided that the dimensions of the aperture geometries are to be equal in the x- and the y-direction, a circular hole and a square hole, respectively, are possible as aperture geometries. In the case of unequal dimensions of the aperture geometry of the apertures 3 in the x- and the y-direction, one can distinguish between a rectangular or an elliptical aperture 3 (see FIGS. 5a to 5d).

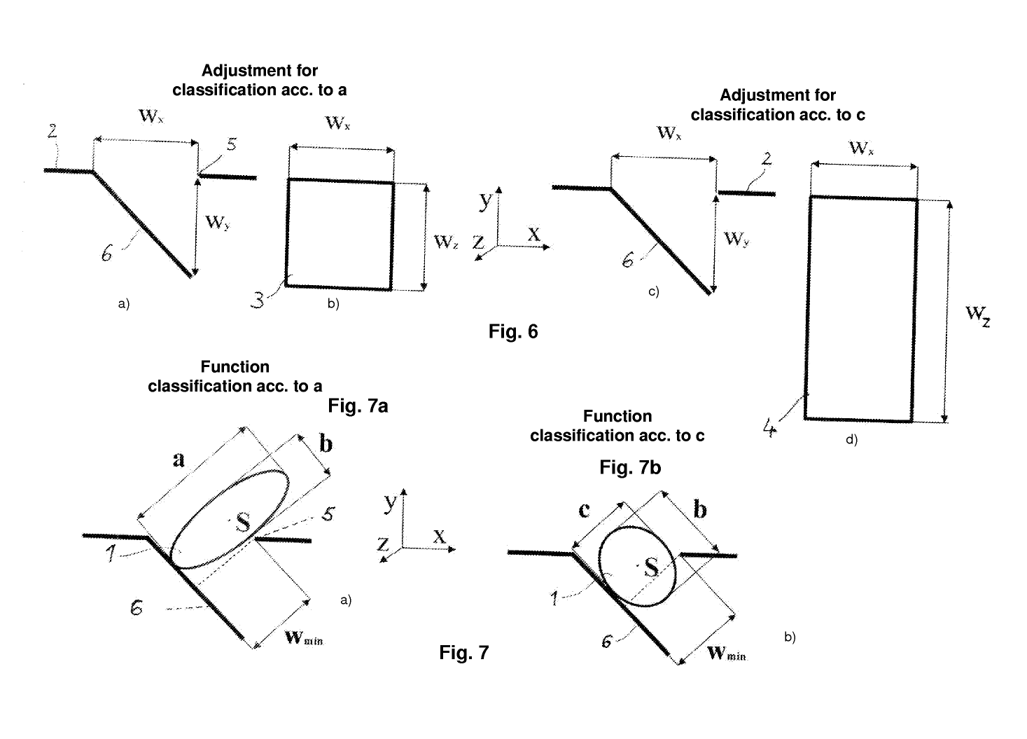

In FIG. 6, possible aperture geometries for a three-dimensional screen lining 2 (“3D” screen lining”) are shown. By using a screen lining 2 having a three-dimensional aperture geometry, one can basically classify according to the main dimension a (maximal largest dimension, linear dimension) or according to the main dimension c (maximal smallest dimension, thickness).

Preferably, a square opening 3 is used for a classification according to the main dimension a for the aperture geometry in the x-z classification plane, as it is shown in FIGS. 6a, 6b (sectional view (FIG. 6a) and plan view (FIG. 6b)). For a classification according to the main dimension c (thickness), a rectangular aperture geometry is preferably provided for an aperture 4 in the x-z classification plane. In both cases, a distance w_{y} decides on a passage of the particle 1 through the screen geometry.

Below, the functionality of the three-dimensional (3D) aperture geometry of the screen lining 2 in a classification according to the main dimension a or c in FIG. 7 is shown with an ellipsoid as an example (a>b>c).

As illustrated in FIG. 7a, if a square aperture geometry in the x-z plane is used for a classification according to the main dimension a, the particle 1 falls over an edge 5 into the x-z plane, as, provided that a>b, it is forced to fall through the x-z plane (classification plane) with its main dimension b (width). The particle 1 subsequently falls onto a plane 6 which is formed by cutting in and bending a flap on three sides from a perforated plate when the screen 2 is manufactured, the flap determining the square opening of the aperture (cf. FIG. 6), and besides this plane 6, the particle 1 still touches the edge 5. A dimension Wₘᵢₙ as vertical dimension between the edge 5 and the plane 6 decides on the probability of the passage of the particle 1. Only those particles 1 pass through the formed three-dimensional aperture which satisfy the prerequisite a<Wₘᵢₙ (cf. also FIG. 7b), taking into consideration the center of gravity of the particle S, the effective direction of the used mode of vibration (direction of dynamic effect) and the existing friction conditions.

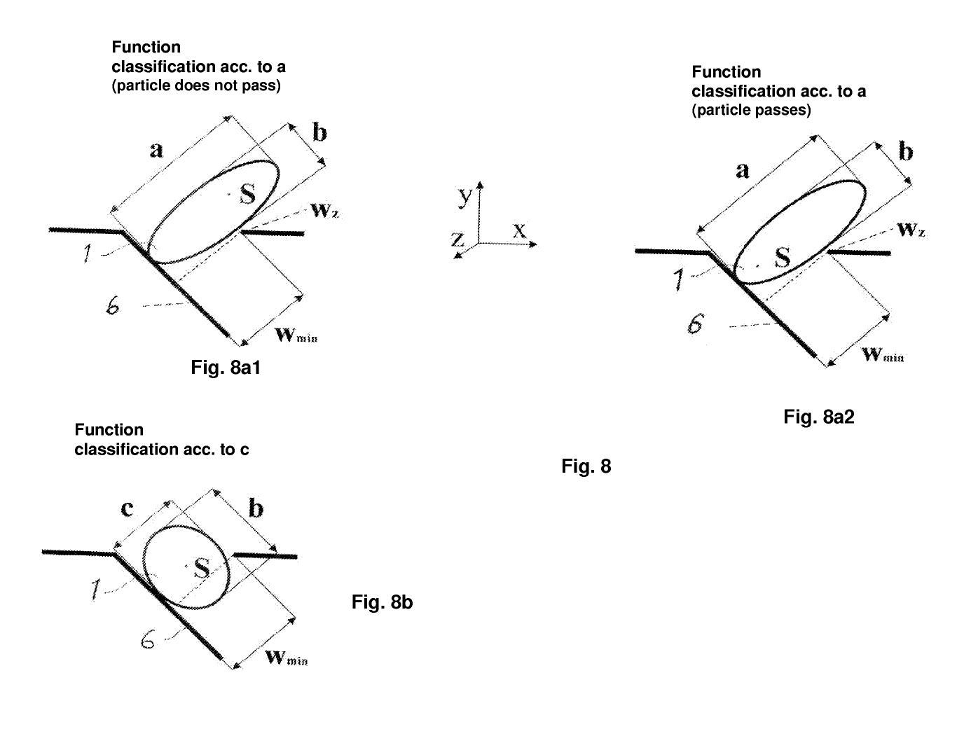

A functionality of the 3D screen geometry in a classification according to the main dimension a or according to the main dimension c, respectively, is shown in FIG. 8 with an ellipsoid with a>b>c as an example.

FIG. 8 illustrates the function of a classification according to the main dimension a with a three-dimensional aperture geometry of the aperture 3, again with a square aperture geometry (cf. FIG. 8a) in the x-z plane (classification plane), wherein the particle 1 falls over the edge 5 (W_{z}) into the x-z plane due to a position of its center of gravity S. Provided that a>b, the particle 1 is forced to fall through the x-z plane (classification plane) with the main dimension b (width). The particle 1 subsequently falls onto the bent plane 6 and does not only touch this partially cut-out and bent portion of a perforated plate 2 forming the classification plane, but also touches the edge 5 designated with W_{z} in FIG. 6b, as well as the edges Wₓ of the aperture arranged offset by 90° with respect thereto (cf. FIG. 6b), i.e., the particle 1 is supported by three points of contact.

The degree of the bending of the plane 6, i.e., the dimension Wₘᵢₙ as vertical distance between the edge 5 (W_{z}) and the plane 6, the position of the center of gravity S, a coefficient of friction of the material combination particle 1/classification or screen lining 2, and an effective direction of the used mode of vibration of the vibrating screen decide on the passage of the particle 1.

There are two possibilities for the passage behavior of the particles 1 which depend on the above mentioned parameters. If the center of gravity of the particle 1 is above the edge 5 as represented in FIG. 8a1, the particle 1 is ejected depending on its length, the direction of the dynamic effect of the vibration and the existing friction conditions. If the center of gravity of the particle 1 is below the edge 5 as represented in FIG. 8a2, the particle 1 passes through the 3D square aperture geometry depending on its length, the direction of the dynamic effect of the vibration and the existing friction conditions.

If a square aperture geometry is used in the x-z planes for the classification according to the main dimension c (cf. FIG. 8b), the particle 1 falls over the edge 5 (W_{z}) into the x-z plane due to a position of its center of gravity S, as its main dimension a is oriented at the edge 5 (W_{z}), provided that W_{z}>Wₓ (cf. FIG. 6d).

Here, too, a dimension Wₘᵢₙ (cf. FIG. 8b) as vertical distance between the edge 5 (W_{z}) and the plane 6, the position of the center of gravity S, the coefficient of friction of the material combination particle 1/classification or screen lining 2, and an effective direction of the used mode of vibration (when the screen is designed as vibrating screen) decide on the passage of the particle 1 through the apertures 3 of the screen. Only those particles 1 pass through the screen geometry which satisfy the prerequisite c<Wₘᵢₙ (cf. FIG. 8b).

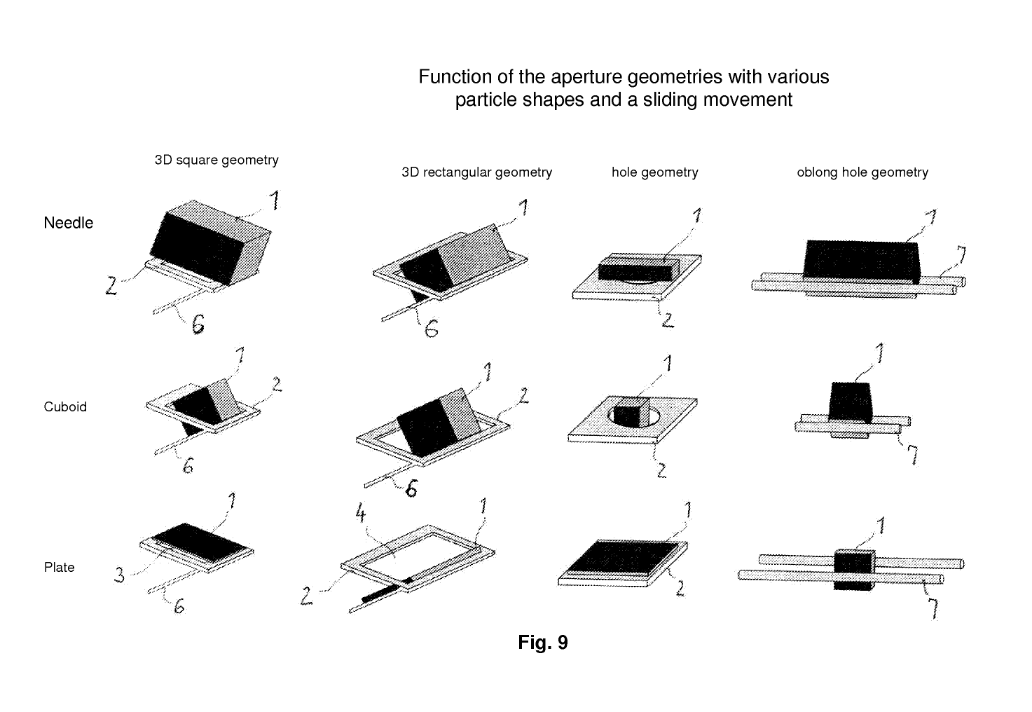

FIGS. 9 and 10 illustrate in a three-dimensional, schematic representation the behavior of the particles 1 in connection with different aperture geometries of the screen 2 for the two particle movements “sliding” and “throwing” (cf. FIG. 4).

In the figures, the passage behavior is represented depending on the aperture geometry for acicular products, cubic products and plate-like products, i.e., for the classification according to a main dimension a, b or c. Based on the above explained embodiments, a procedural selection for the possible classification can be made by using the parameters, the aperture geometry of the screen 2 and the particle movement (“sliding” and “throwing”, cf. FIG. 4).

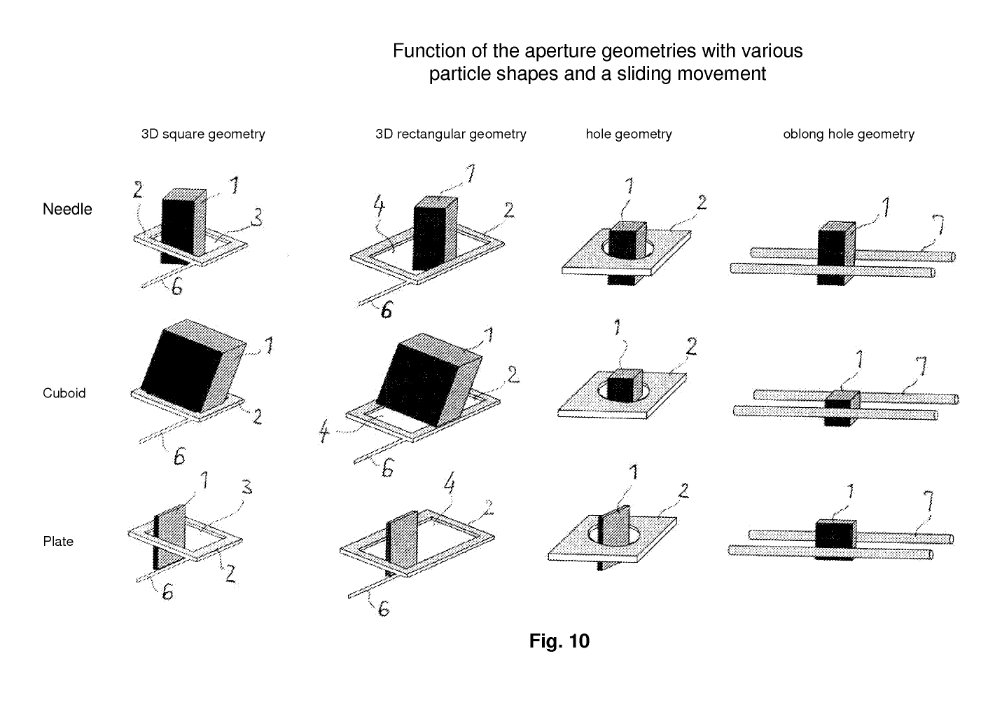

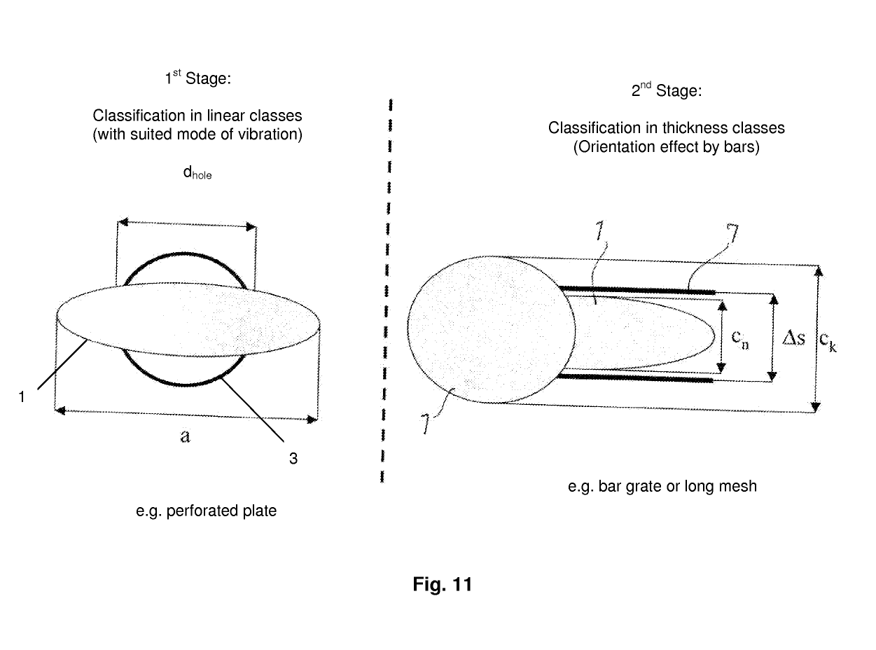

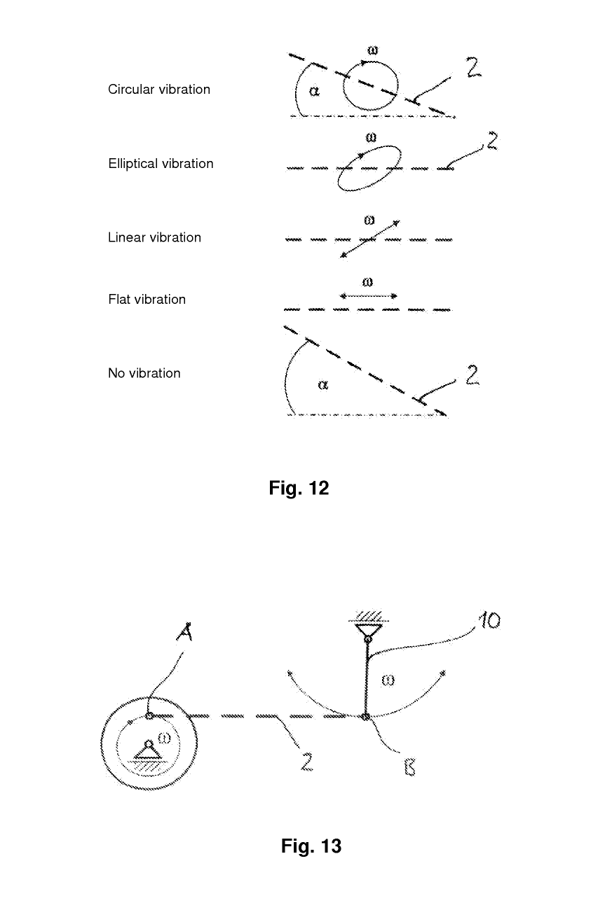

FIG. 11 illustrates in a schematic representation the active principle of the “double serial classification” with a first classification stage (FIG. 11 left) for the classification according to a maximal length a, wherein a perforated plate with a round aperture 3 is schematically represented as a screen. The diameter of the aperture 3 is designated with dₕₒₗₑ, which determines the corresponding maximal length a of the particles 1 in the first classification stage. The perforated plate can be stimulated by the modes of vibration (elliptical, linear and flat vibration) represented in FIG. 12 for forming a vibrating screen, wherein this first classification stage is followed by a second classification stage (FIG. 11 right) in which a classification according to the particle thickness, i.e., in the direction of the smallest dimension c (here designated with c) is performed. Preferably, here classification by a bar grate 7 or a long mesh can be used as a screen. A bar distance of the bar grate 7 is designated with Δs which determines the corresponding main dimension c of the particles 1 in the second classification stage.

With reference to FIG. 2 (classification variants), for each of the variants (cf. FIG. 2, column 5), the procedural realization possibilities are determined based on the parameters “particle movement” and “aperture geometries,” as represented in FIGS. 9 and 10.

The classification variants each concern the chronological and/or spatial sequence of the first and second classification step for a preferred double serial classification depending on the respective main dimension in the first and/or second classification step.

As was illustrated, the procedural realization possibilities for embodiments of the invention are selected depending on the particle movement (throwing or sliding, cf. FIGS. 4, 9, 10) as well as on the aperture geometry for two-dimensional apertures (round hole, oblong hole) or for three-dimensional aperture geometries (3D square, 3D rectangle). The embodiments explained below refer to the brief designation of FIG. 2 (right column 5).

For the variant “NI,” i.e., for serial classification according to acicularity with a first classification according to the main dimension a and a second classification according to the main dimension b (length and width), there is a preferred method option only for a sliding movement of the particles 1 with Sᵥ₁ and a round hole screen geometry in the first classification step, and for a throwing movement of the particles 1 with a round hole geometry and Sᵥ>1 with a classification according to the width in the second classification within the range of two-dimensional aperture geometries of the screen 2.

With respect to a three-dimensional screen geometry or aperture geometry of the apertures 3, there is a preferred procedural option for the particle movement “throwing” and “sliding” each in square screen apertures, however only for the first classification step.

In summary, for the classification variant NI, only a round or square hole geometry of the apertures 3 with a sliding movement of the particles 1 in the first classification step and a throwing movement for the second classification step (thus separate screens 2 with different drive movements), or else a design of the screen 2 with a three-dimensional aperture geometry and square apertures 3 in the first classification step, for a throwing as well as for a sliding movement of the particles 1, in combination with round or square hole apertures 3 and a throwing movement for the vibrating screen 2 in a second classification step can therefore be considered as preferred embodiments. That means, if a throwing movement is employed, in this case also an integral screen 2 with a first classification according to the main dimension a and a second classification according to the main dimension b can be used on one deck for the variant NI.

Correspondingly, for the variant NII, i.e., again a serial classification according to acicularity, however with a reversed sequence of the classification steps, i.e., first classification according to the width of the particles 1 (main dimension b) and subsequent classification according to the main dimension a (length), there is a preferred method combination in the use of a round hole geometry and a throwing movement for the screen 2 in combination with a sliding movement for the particles 1 in the second classification step with a separate screen 2 with a sliding movement of the particles 1 and a round or rectangular aperture geometry of the apertures 3. Besides this preferred method combination in the region of two-dimensional aperture geometries, there is additionally, in connection with the above explained design of the method in the first classification step, the possibility of effecting the classification in the second classification step (thus according to the main dimension a) by using three-dimensional aperture configurations of the screen 2 for a throwing as well as a sliding movement of the particles 1.

That means, here, too, there is the possibility of an integral screen 2 for the first and the second classification with respect to a screen drive which imparts a throwing movement to the particles 1, or, with a separate embodiment of the second screen 2 and a separate performance of the second classification, also the possibility of also realizing this classification by using a sliding movement of the particles 1.

A further classification variant RI classifies the particles according to cubicity of the particles 1 in the combination of a classification according to the main dimension a (first classification) and a subsequent classification according to the main dimension c (thickness; cf. FIG. 1). Here, classification according to cubicity can be achieved, for example, with an inclined fixed screen 2 for establishing a sliding movement of the particles 1 and a design of the screen 2 with a round hole geometry for the first classification step and an oblong hole geometry for the second classification step, as an alternative, the classification according to the thickness can also be preferably achieved in a throwing movement with an oblong hole geometry of the apertures 3.

As an alternative, a corresponding combination is also possible with a design of the screen 2 for the second classification step as three-dimensional aperture geometry with rectangular apertures 4 for a common sliding movement of the particles 1 in the first or second classification step. As an alternative, such a sliding movement can also be preferably procedurally realized in a three-dimensional aperture geometry in the first classification step (classification according to the main dimension a) for a throwing or sliding movement with a square aperture 3, as well as the combination of three-dimensional aperture geometries with square apertures 3 in a throwing or sliding movement of the particles 1 with the same movement regime in the second classification step with rectangular apertures 4 (cf. FIGS. 5 and 6).

Further classification variants according to FIG. 2 for the serial classification according to cubicity, where the classification steps 1 and 2 are interchanged, are the variant RH as well as the two method variants with the classification according to flatness for the variants P1 and PH, which simultaneously result (as explained above) in corresponding constructive embodiments for the screen on the one hand, and with respect to common or separate vibration drives on the other hand.

From a combination of preferred procedural constructions with constructive solution variants with respect to possible modes of vibration for the screen (cf. FIG. 12) or the corresponding setting angles α, e.g., for fixed, inclined screens and the possible coupling of the first and the second classification steps, preferred constructive embodiments for a sorting machine or for sorting sequences can be obtained depending on the desired sorting result (classification according to the shape on the basis of main parameters of the particle).

With respect to the vibration geometries, reference is basically made to FIG. 12. Here, the parameter “setting angle α” is defined by two possibilities. The screen plane (classification plane) is either set at a predetermined angle or inclined, then α>0, or the screen plane or classification plane is arranged to be horizontal, this is designated with α=0. Here, a combination of setting angle and mode of vibration is considered to be preferred if a transport of the particles 1 as charging material is ensured in the classification plane (along the screen plane) by the combination of vibration and/or setting angle.

As was already explained, a third element for the advantageous embodiment of the sorting method consists in the possibility of integrally designing the first classification and the second classification in one piece, possibly with a common screen (permitting the construction of compact sorting machines), where, taking into consideration the examined parameters aperture geometry of the apertures and particle movement (throwing or sliding) for an integral screen which can perform both classification steps in sections, basically only those configurations can be considered which permit the use of the same mode of vibration or mode of stimulation for the particle transport in the classification plane (the same mode of vibration).

Here, there is only an exception concerning the use of a circular and partially circular vibration in the coupled operation, which can be realized in a combination of a guided circular vibration and a coupling rod. Such an embodiment is represented in FIG. 13 as a mechanical equivalent circuit diagram. Here, the screen 2 on the one hand (linkage point A) can be stimulated by a circular vibration, while an elliptical or arched vibration is imparted to the screen 2 at its other end (linkage point B) by using a corresponding linkage of a coupling rod 10 with a vibration in the direction of arrow. In such a case, the screen 2 can also include two classification regions for a first classification in the left region and a second classification in the right region of the screen 2.

The combination of the constructive prerequisites, connected with procedural solution conditions, permits a preferred selection of method procedures and variants of construction for the process and apparatus design of sorting machines according to preferred embodiments, which comprise at least one first and one second classification resulting in sorted fractions of particles of a defined particle shape.

At this point, it is again pointed out that the first and the second classifications can also be performed at a great chronological or spatial distance by individual aggregates (down to a manual design in connection with small charging quantities), wherein in the combination of the first and the second classifications, the desired sorting result is always achieved according to the grain shape and, as desired, according to one of the three main dimensions of the particles.

The second classification can also be followed by a third classification, according to the grain shape or a further sorting according to other particle properties or parameters, which can be important in particular in case of particle mixtures of different materials. That means, a combination of a serial classification (=sorting according to the grain shape) with at least two classification stages in combination with a sorting according to other particle parameters or properties can be performed. Preferably, for reducing the influence of the grain shape that is negatively superimposed on the grain shape effect and thus the sorting effect, a fractioning is performed by the first classification step, or this fractioning is combined with the first classification step.

The above-mentioned connection of the procedurally preferred solutions with the constructively possible or preferred solutions results in the formation of technically realizable solutions.

Also before the first classification, possibly together with the classification according to the particle size (fractioning), sorting can be performed according to other parameters of the particles, such as density, electrical or thermal conductivity or the like. That means, the double serial classification can be integrated in process managements of a different type, in continuous or interrupted, sectional method procedures.

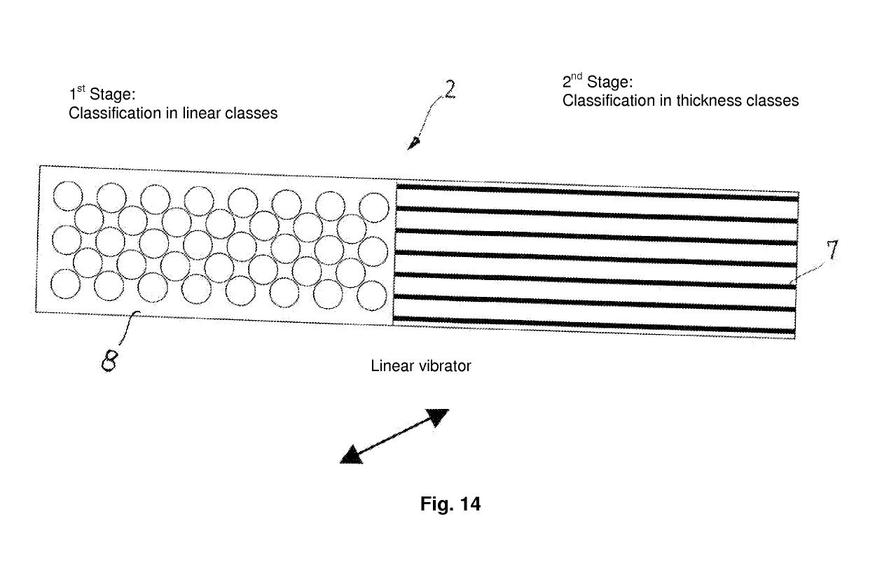

In FIG. 14, corresponding to the representation of the active principle of the “double serial classification” for “fractioning” the particulate charging material into an acicular, cubic or flat “fraction,” a screen 2 with a perforated plate 8 in the first classification stage (classification into length classes) and subsequently with a bar grate 7 in the second classification stage for the classification into thickness classes is again schematically shown, so that as a result a sorting according to cubicity is performed (classification according to the main dimensions a and c), wherein the screen 2 here is stimulated via a linear vibrator.

FIG. 15 schematically illustrates a procedural model with a charge and classification in length classes in the first classification stage as well as classification in thickness classes in the second classification stage for obtaining a non-cubic fraction in the screen underflow, while a cubic fraction is obtained in the screen overflow, which is possibly forwarded to further classification. In this case, the first classification step also serves to minimize the influence of the grain shape, which is often negatively superimposed on the grain shape effect and thus the sorting effect, so that the first classification stage at the same time causes a fractioning of the charging material 1 (here in two fractions).

The following figures describe preferred embodiments for sorting apparatuses (sorting machines), each distinguished by their sorting according to acicularity, cubicity or flatness and depending on the construction with a performance of the first and the second classification steps on a screen 2 or on two separate screens 2.

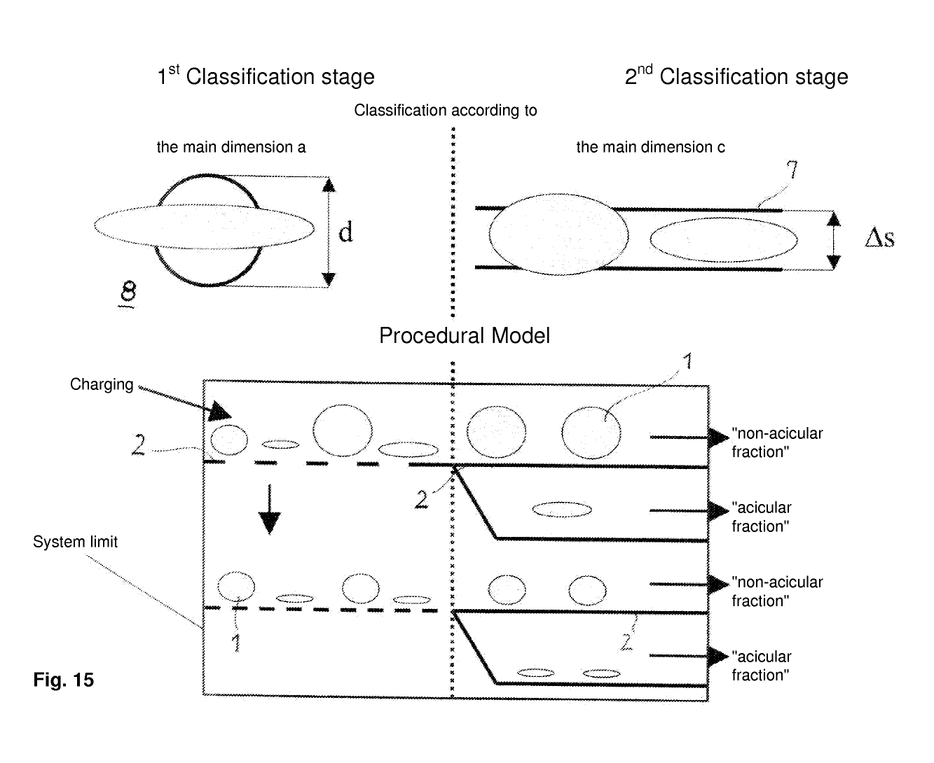

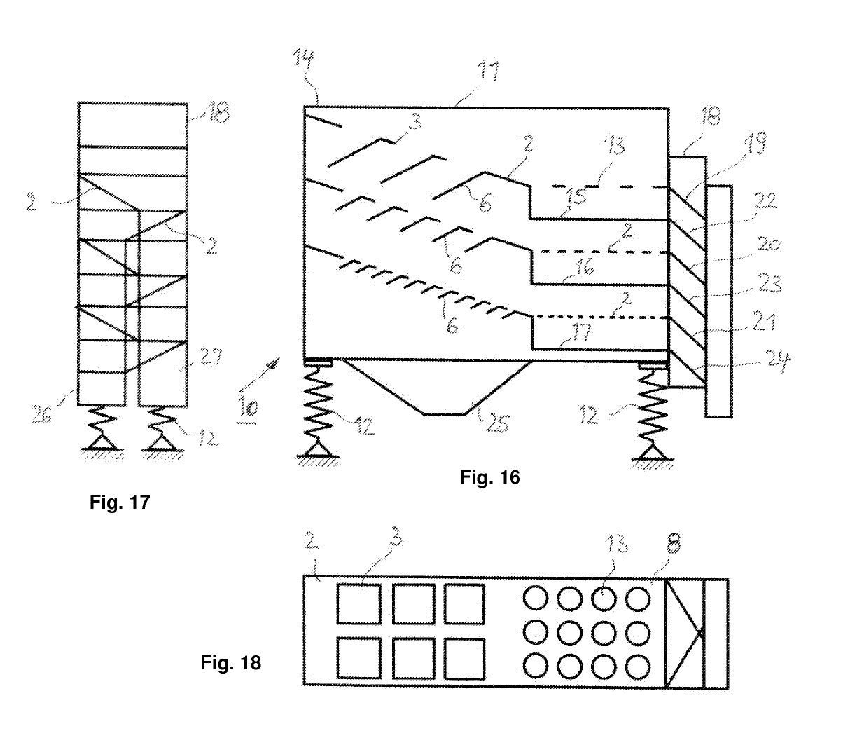

FIGS. 16 to 18 illustrate a sorting machine 10 for sorting according to acicularity, i.e., according to the dimensions a and b, wherein both classification steps are performed on one deck, i.e., with an integral screen 2. The screens 2 in the sorting machine or the sorting apparatus 10, which are located in a housing 11 which is supported via support springs 12, here comprise 3D square holes 3 in connection with round holes 13 of a perforated plate 8. Three fractions are provided in the region of the first classification step (3D square holes 3), wherein a feed is provided at 14.

The sorting machine 10 represented in FIGS. 16 to 18 consists of three classification planes arranged one upon the other for oversize, intermediate and fine material. The screen 2 forms a screen surface for the linear dimension a of the particles 1. In the second classification step, a classification according to the particle width b is performed by using the round holes 13.

From the corresponding decks 15 to 17 with the oversize, intermediate and fine material classified according to their acicularity, the same reaches a housing 18 of a product discharge section, wherein the delivery chutes 19 to 21 for the non-acicular oversize, intermediate and fine material is located, as well as the corresponding delivery chutes 22 to 24 for the acicular oversize, intermediate and fine material. Numeral 25 designates an undersize discharge collector.

In the schematic side view of the housing for the product discharge section, a discharge for acicular material is designated with 26, and a discharge for non-acicular material is designated with 27. That means, in this case the oversize, intermediate and fine material sorted according to their acicularity is joined again. Of course, it is also possible to maintain the fractions and to prevent them from being brought together in the discharge 26 (or 27, respectively).

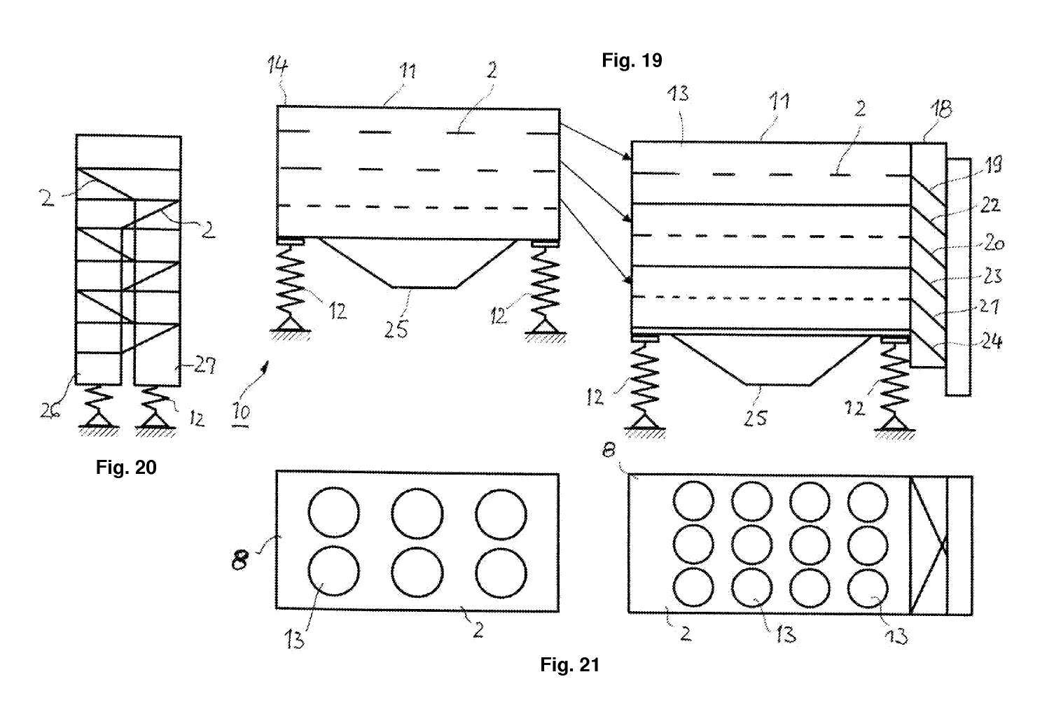

In FIGS. 19 to 21 a further embodiment for a sorting apparatus or sorting machine 10 according to acicularity is schematically shown, wherein here the first and second classification stages are separate and performed on two decks, i.e., two screens 2 separate for each fraction. In this case, screens 2 each designed as perforated plates 8 are used in the first and second classification stages. Here, three fractions (oversize, intermediate and fine material) are formed again. For the rest, reference is made to the description of the embodiment with an integral screen.

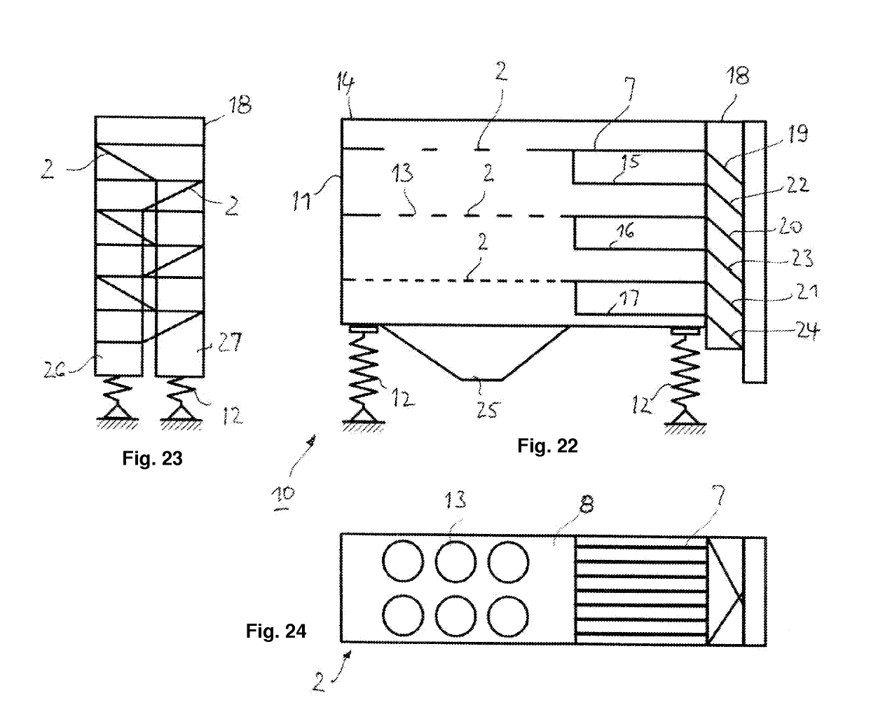

In FIGS. 22 to 24 a sorting machine 10 or a sorting apparatus 10 for sorting according to cubicity is shown in a schematic representation. The integral screen 2 is here embodied as a perforated plate 8 in connection with a bar grate 7. Here, too, three fractions are formed again, and first a sorting into oversize, intermediate and fine material is effected according to cubicity, so that in the discharge 26 non-cubic material and in the discharge 27 cubic material can be formed and discharged where the three fractions are brought together. Here, too, a joining of the fractions oversize, intermediate and fine material can be of course dispensed with, and the material sorted according to cubicity and to the particle size can be discharged from the sorting device in each case.

Correspondingly as in the sorting apparatus or sorting machine 10 according to acicularity according to FIGS. 19 to 21, in FIGS. 25 to 27, too, sorting according to cubicity on two decks is shown, i.e., the first and the second classification steps are divided into two screens 2. For the rest, same reference numerals designate the same elements as in the above embodiments starting with FIG. 16.

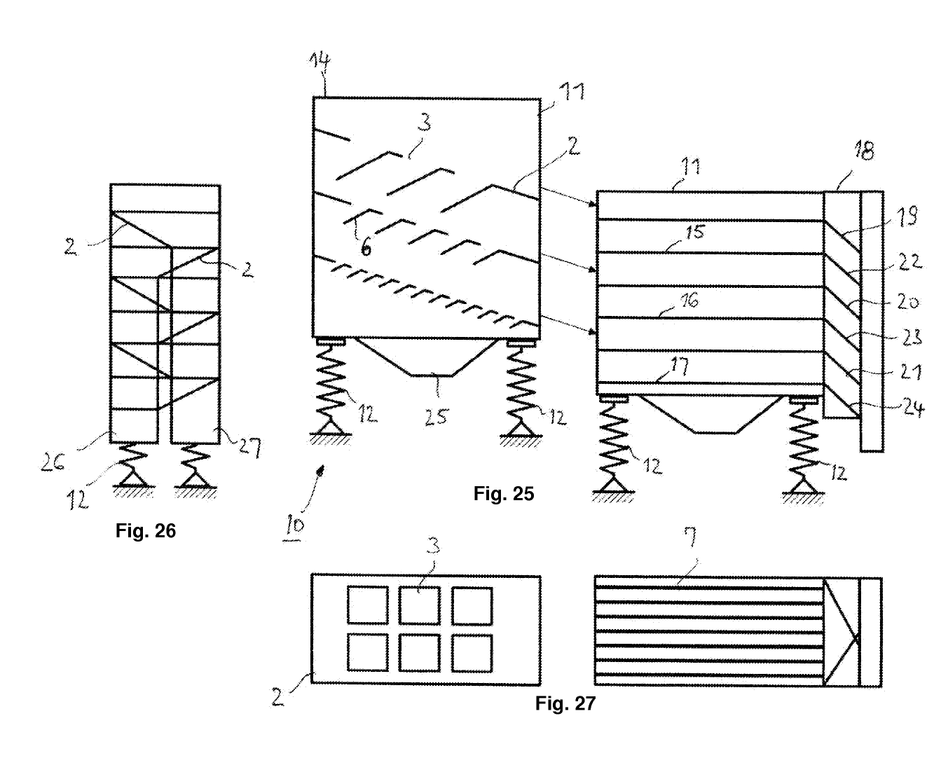

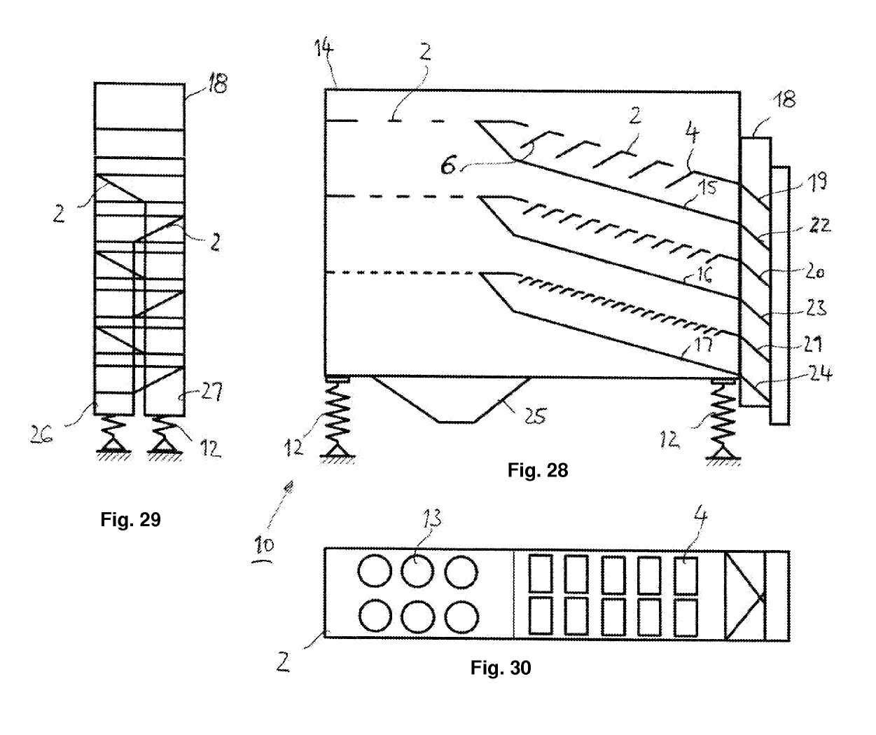

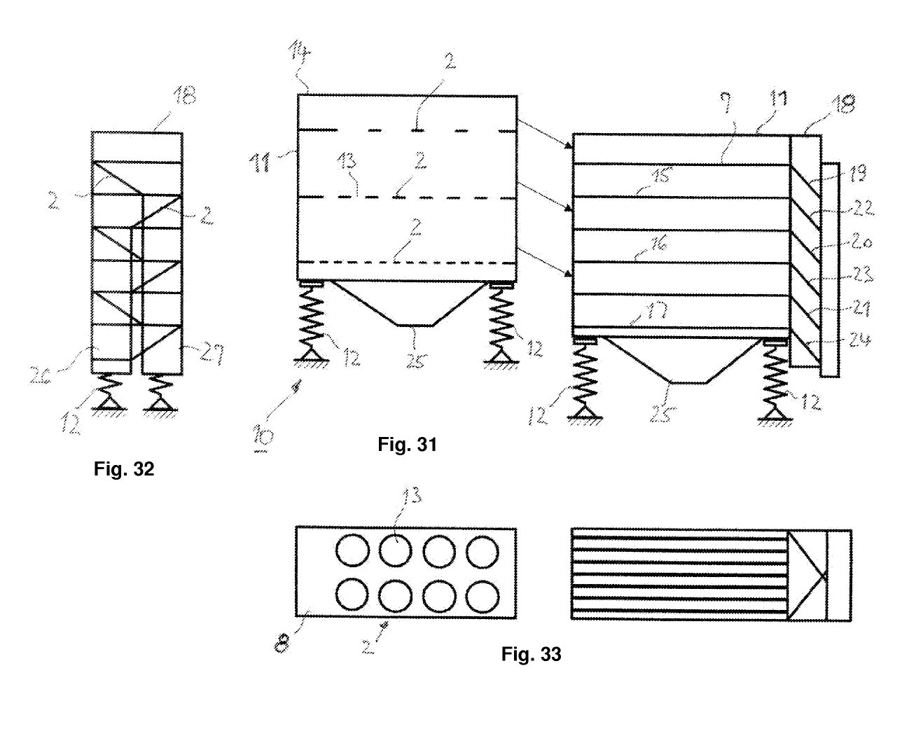

Finally, a corresponding representation is shown in FIGS. 28 to 30 for sorting into three size fractions according to flatness with a perforated plate and 3D rectangular openings in the first and the second classification steps by using an integral uniform screen 2, while in FIGS. 31 to 33 sorting according to flatness with a distribution of the first and second classification steps onto two separate screens 2 is shown. Here, reference is made again to the above explanations with the corresponding reference numerals with respect to the individual elements.

By the invention, an advantageous sorting of particles according to the particle shape is possible, resulting in essentially more efficient sorting processes and optimized or completely new material properties. For example, a clearly improved packing density as well as isotropy or anisotropy can be achieved if suitable pre-sorted particles are used. The processibility or reactivity of particles can also be modified. Moreover, the ability of conveying materials can be clearly improved, if an advantageous sorting of particles in accordance with the invention has been effected beforehand.

The invention will be employed, among others, but not exclusively, for sorting processes in agriculture, such as in the harvest and further processing of fruits, vegetables, berries and cereals, for seeds, fertilizing agents, feedstuff, spices, coffee beans, nuts, tobacco, tea, eggs or other animal products, as well as fish, meat or (intermediate) products therefrom, as well as accumulated waste or side products; in industry for cleaning or processing raw materials, such as stone chippings, broken stone, ores, coals, salts, wood materials, as well as semi-finished or intermediate products, natural or synthetic bulk materials or powders, such as lime, cement, fibers, coke, natural graphite, synthetic graphite, plastics and their additives, composite materials, ceramics, glass, metal, wood chips, additives for industrial processes, blasting shots or abrasive compounds, screws, nails, coins, precious stones, semiprecious stones, scrap, recycling materials or other streams of waste, bulk materials or powders in the chemical or pharmaceutical industry, such as washing powders, pigments, beds for reactors, catalysts, medical or cosmetic active substances and additives or tablets.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method for sorting particles, comprising sorting the particles in at least two classification stages according to their particle shape in a at least one of a chronological sequence and a spatial sequence.

2. The method according to claim 1, wherein the sorting of the particles is performed according to their particle geometry (dimensions a, b, c).

3. The method according to claim 2, wherein the sorting of the particles is performed according to at least one of their parameters acicularity, cubicity and flatness.

4. The method according to claim 3, wherein the sorting according to one of these parameters is chronologically and/or spatially preceding a further sorting according to at least one further of these parameters.

5. The method according to claim 1, wherein the sorting is effected by two- or three-dimensional classification.

6. The method according to claim 5, wherein the classification is performed in a vibrating or not vibrating, optionally inclined, classification plane.

7. The method according to claim 6, wherein the classification plane comprises at least one of square, rectangular, elliptical, and circular apertures.

8. The method according to claim 7, wherein the particles are guided along an inclined plane in the region of the apertures.

9. The method according to claim 7, wherein an aperture is determined by a vertical distance of an inclined plane from an opposite edge defining the aperture in the classification plane.

10. The method according to claim 2, wherein first a classification of the particles according to a maximal particle dimension (a), and then a classification of the particles according to a median particle dimension (b) essentially perpendicular to the maximal particle dimension, is performed.

11. The method according to claim 10, wherein subsequently a classification of the particles according to the maximal particle dimension (a), and then a classification of the particles according to a minimal particle dimension (c) essentially perpendicular to the maximal and the median particle dimensions, or subsequently first a classification of the particles according to the median particle dimension (b) perpendicular to the maximal particle dimension, and then a classification of the particles according to the minimal particle dimension (c) essentially perpendicular to the maximal and the median particle dimensions, are performed.

12. The method according to claim 3, wherein a sequence of the sorting of the particles according to at least one of their acicularity, cubicity and flatness is freely selected.

13. The method according to claim 1, wherein a classification of the particles is performed by screening each.

14. The method according to claim 1, wherein the sorting of the particles is performed by classification in at least one classification plane with an optionally moving screen and predetermined aperture geometries of apertures of the screen.

15. The method according to claim 1, wherein the sorting is performed by classification of the particles with a moving screen by circular, elliptical, linear or flat vibration, or with a non-moving screen having an inclined screen plane.

16. The method according to claim 1, wherein a classification of the particles is performed by using screens having apertures of predetermined aperture geometries selected from round hole, oblong hole, 3D square hole or 3D oblong hole, and combinations thereof.

17. The method according to claim 6, wherein at least one of a vibration frequency and an amplitude of a vibrating screen is adjusted specifically to the particles for adjusting a predetermined particle movement.

18. The method according to claim 1, wherein the sorting is performed by classification of the particles according to a maximal particle dimension (a) with a predetermined round hole, oblong hole, 3D square hole or a 3D rectangular hole.

19. The method according to claim 1, wherein the sorting is performed by classification of the particles with a predetermined round hole according to a median particle dimension (b) essentially perpendicular to a maximal particle dimension (a).

20. The method according to claim 1, wherein the sorting is performed by classification of the particles with a predetermined oblong hole or 3D rectangular hole according to a minimal particle dimension (c) essentially perpendicular to a maximal particle dimension (a).

21. The method according to claim 1, wherein the sorting of the particles is preceded by fractioning.

22. The method according to claim 21, wherein the particles of different fractions are sorted in parallel by classification in a common device.

23. The method according to claim 21, wherein the fractioning of the particles is performed together with a first sorting by classification.

24. The method according to claim 1, wherein the sorting is performed in at least two classification stages of a common sorting device.

25. The method according to claim 24, wherein the sorting is performed for both classification stages with one common perforated plate.

26. The method according to claim 1, wherein the sorting is performed in at least two classification stages having separate sorting devices in separate housings.

27. The method according to claim 1, wherein the sorting by classification of the particles according to a minimal particle dimension (c) essentially perpendicular to a maximal particle dimension (a) is performed with a bar grate having a predetermined bar distance (Δs) or a long mesh having a predetermined mesh distance (Δs) as screen (2).

28. An apparatus for sorting particles of a charging material according to their particle shape in at least two classification stages in a chronological and/or spatial sequence, the apparatus comprising at least two of the following classifiers: a first classifier for classifying the particles according to a maximal particle dimension (a) of the particles, a second classifier for classifying the particles according to a median particle dimension (b) of the particles, wherein dimension (b) is essentially perpendicular to the maximal particle dimension (a), and a third classifier for classifying the particles according to a minimal particle dimension (c), wherein the minimal particle dimension (c) is essentially perpendicular to the maximal particle dimension (a) and the median particle dimension (b).

29. The apparatus according to claim 28, wherein the chronological and/or spatial sequence of the classification stages is variable.

30. The apparatus according to claim 28, wherein each of the classifiers comprises a screen.

31. The apparatus according to claim 28, wherein at least two of the classifiers are designed integrally by an integrated screen having apertures of different aperture geometries.

32. The apparatus according to claim 28, wherein at least two of the classifiers are designed separately by separate screens having apertures with a same or a different aperture geometry.

33. The apparatus according to claim 28, wherein at least one of the classifiers comprises a screen having a circular, elliptical, linear or flat vibrator, or a fixed classification plane formed by an inclined screen.

34. The apparatus according to claim 28, wherein at least one of the classifiers comprises a screen having apertures of predetermined aperture geometries selected from a round hole (13), an oblong hole, a 3D square hole (3), a 3D oblong hole (4), or a combination thereof.

35. The apparatus according to claim 28, wherein at least one of the classifiers comprises a vibrating screen having a vibration frequency and/or amplitude which can be adjusted product-specifically for adjusting a predetermined particle movement, optionally a predetermined particle throw.

36. The apparatus according to claim 28, wherein the first classifier for classifying the particles according to a maximal particle dimension (a) comprises a screen having a perforation pattern with a predetermined round hole, oblong hole, 3D square hole, 3D oblong hole, or a combination thereof.

37. The apparatus according to claim 28, wherein the second classifier for classifying the particles according to the median particle dimension (b) essentially perpendicular to the maximal particle dimension (a) comprises a screen having a predetermined hole diameter (Dₕₒₗₑ) selected from a perforated plate or a screen with a predetermined mesh size.

38. The apparatus according to claim 28, wherein the third classifier for classifying the particles according to the minimal particle dimension (c) essentially perpendicular to the maximal and the median particle dimension (a, b) comprises a screen formed of bars or a long mesh having a predetermined bar or mesh distance (Δs) or a 3D rectangular hole lining.

39. The apparatus according to claim 28, wherein the first and second classifiers comprise first and a second screen, wherein the first and second screens have at least one of a common housing, a common drive means and a conveyor guiding the particles over the classifier.

40. The apparatus according to claim 30, wherein a first screen is provided for a classification of the particles according to a maximal particle length, a second screen is provided for a classification of the particles according to a maximal particle width essentially perpendicular to the maximal particle length, and a third screen is provided for classification of the particles according to a maximal particle thickness essentially perpendicular to the maximal particle length and the maximal particle width.

41. The apparatus according to claim 28, comprising a fractioning unit and a sorting unit in a common housing, wherein the sorting unit performs a classification according to at least one of maximal particle length, maximal particle width and maximal particle thickness.

42. The apparatus according to claim 41, wherein the fractioning unit is at the same time the first classifier.

43. The method according to claim 1, wherein the particles are selected from coal for blast furnaces, broken stone/stone chippings, powder, bed particles for fixed bed reactors.

44. The apparatus according to claim 28, wherein the particles are selected from coal for blast furnaces, broken stone/stone chippings, powder, bed particles for fixed bed reactors.
